(19) United States
(12) Patent Application Publication
(10) Pub. No.: US 2016/0034864 A1
(43) Pub. Date: Feb. 4, 2016

(54) Payment Mode Selection

(71) Applicant: MasterCard International Incorporated, Purchase, NY (US)

(72) Inventor: Jennifer May Macrae, London (GB)

(21) Appl. No.: 14/815,630

(22) Filed: Jul. 31, 2015

(30) Foreign Application Priority Data
Jul. 31, 2014 (GB) 1413621.2

(51) Int. Cl. G06Q 20/10; G06Q 20/32

(52) U.S. Cl. CPC G06Q 20/10; G06Q 20/3224; G06Q 20/3276; G06Q 20/3278

(57) ABSTRACT

A system, method, and computer-readable storage medium configured to the electronic detection and presentation of available payment types by a mobile user device.

### RELATED APPLICATIONS

This application claims priority to UK Patent Application Number 1413621.2, filed on the 31^{st} of July, 2014, entitled “Payment Mode Selection,” the contents of which are incorporated herein by reference.

### BACKGROUND

1. Field of the Disclosure

Aspects of the disclosure relate in general to the electronic detection and presentation of available payment types by a mobile user device.

2. Description of the Related Art

Traditional Point-of-Sale (POS) cash, check, debit and credit card transactions are increasingly being replaced or supplemented by quicker, more convenient or more economical payment methods such as self-checkout, contactless and e-commerce. For example, it is sometimes now possible to pay for goods using “tap and pay” or “scan and pay”.

In “tap and pay” schemes contactless technology, such as Near Field Communication (NFC), is used to transfer data in a similar manner to a traditional debit or credit card chip reader. However, instead of having to insert a card into a reader and enter a Personal Identification Number (PIN), payment can be effected by holding an NFC-enabled card or mobile device (such as a smartphone or tablet) proximate to an NFC reader at a POS.

In “scan and pay” schemes the PUS can be clone away with altogether; payment can be effected in-aisle. Personal mobile devices (such as smartphones and tablets) can be used to scan barcodes (whether linear or matrix) on products and payment for the products can be effected in response over the Internet, such as by e-commerce.

Points-of-Sale can also be mobile; a member of staff carrying a mobile device equipped with e-commerce technology can roam a store, restaurant or bar attending to customers.

### SUMMARY

Embodiments include a system, device, method and computer-readable medium to the electronic detection and presentation of available payment types by a mobile user device.

In a mobile device embodiment, the mobile device has a transceiver, a processor, and a user interface. The transceiver electronically polls to determine availability to the mobile device of each of a plurality of communications channels. Based on the availability of the each of the plurality of communication channels, the processor determines that one or more modes of payment are available to a user. The user interface presents the user with a list of the one or more modes of payment that are available.

### BRIEF DESCRIPTION OF THE DRAWINGS

FIG. 1 illustrates an example method performed by a mobile user device to electronically detect and present available forms of payment.

FIG. 2 illustrates an example system to electronically detect and present available forms of payment.

FIG. 3 is a flowchart detailing an example processing flow for presenting payment mode options to a user for a particular transaction.

FIGS. 4A to 4C show example Graphical User Interfaces (GUIs) for presenting the messages of FIG. 3.

FIG. 5 is a flowchart detailing another example processing flow for presenting payment mode options to a user for a particular transaction.

FIG. 6 is a flowchart illustrating an example method of determining a mobile device's location.

FIG. 7 illustrates an example method 700 for payment mode selection in a restaurant.

### DETAILED DESCRIPTION

Where multiple payment methods are available for making a transaction, a consumer may wish to choose from these methods the one that is most convenient for them at the time of purchase. Where a mobile device is generally capable of effecting payment by multiple methods, but in the specific circumstances of a particular transaction not all of these methods are available, a mobile device ma present the user with a list of only those payment methods available for the current transaction so that the user does not attempt payment by an unavailable methods.

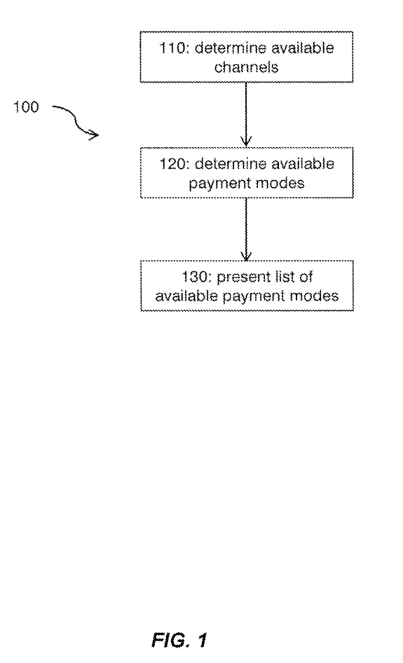

FIG. 1 illustrates an example method 100 performed by a mobile user device, constructed and operative in accordance with embodiments of the present disclosure. At 110, one or more communications channels available to the user device are determined.

At 120, one or more payment modes available to the user through use of said one or more communications channels are determined.

A mobile user device, or an in-store device (whether staff-held or located at an unmanned electronic POS), may be capable of determining which payment methods are available for a particular transaction by determining one or more local environmental conditions.

For example, e-commerce methods may only be available if one of cellular telephony network signal strength and WiFi signal strength are strong enough and/or reliable enough. This can be determined through Quality of Service (QoS) measurements such as Received Signal Strength Indicator (RSSI), Bit Error Rate (BER), available bandwidth, throughput, latency and the like. The determination could be made with reference to a minimum threshold value.

Similarly, contactless payment methods will only be available if the merchant premises provide contactless POS devices. This can be determined by checking whether the mobile device's location is within merchant premises registered for contactless payment. Registration records may be held in a database stored on the mobile device or retrievable by the mobile device from a remote server over a cellular telephony network and/or the Internet.

The mobile device's location may be determined by the user “checking in” in store, for example by tapping a contactless reader or scanning a line or matrix barcode. Such a barcode could be on a wall poster in the store, affixed to the product the user wishes to purchase or alongside an item on a bar, cafe or restaurant menu the user wishes to order.

Alternatively, a Global Positioning System (GPS) enabled mobile device could determine its location using GPS satellites. The aforementioned database could store a range of GPS coordinates covered by each registered store. Similarly, if the mobile device is connected to a network, for example a wireless personal area network (WPAN) such as a WiFi or Bluetooth™ Low Energy (BLE) network, the location of the device could be determined as within range of whatever access point/base station it is connected to.

Environmental conditions such as cellular telephony network and WiFi signal strength and location can be checked automatically by the mobile device on a periodic basis, for example once every five minutes. This would result in the desired information on available payment modes being available instantaneously when a user requests it.

Alternatively, in order to conserve electrical power, processing power and bandwidth, environmental conditions may only be checked on-demand by the user, for example when the user opens a mobile payment application or selects a command within one.

At 130, a list of said payment modes is presented to the user.

A list of available modes of payment can be presented to the user in response to the user opening a payment application on their device, scanning a product barcode with their device or checking-in at a store, for example by tapping or scanning as explained above.

Mobile payment could comprise the user selecting one of the payment modes presented. It may also be necessary to subsequently scan a barcode or tap the user device on a contactless reader, or these actions could constitute selection of a presented available payment mode.

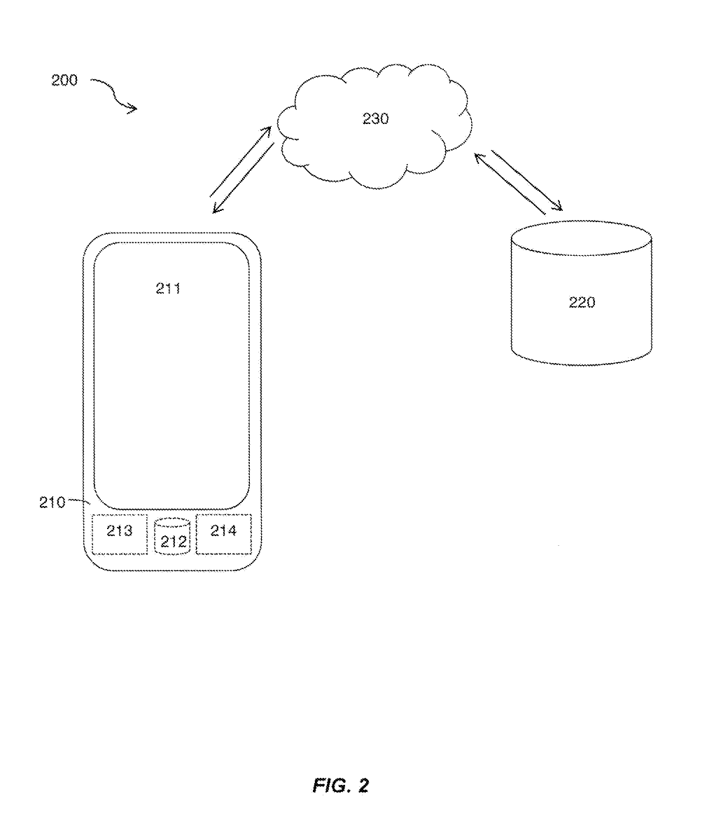

FIG. 2 illustrates an example system 200 to perform such a method, constructed and operative in accordance with embodiments of the present disclosure. A user device 210 comprises a user interface device 211 a memory 212, a processor 213 and a transceiver 214. It may also comprise other typical user device components such as a battery. User interface device 211 could, for example, be a screen (e.g. a touchscreen), a speaker or one or more Light Emitting Diodes (LEDs) used to indicate to the user which payment modes are available. User device 210 could Comprise one or more further user interfaces such as a touchpad, one or more buttons, a keypad or keyboard, a microphone, a barcode scanner and the like. Memory 212 stores computer program instructions for performing the method and may be integral with the user device or a removable drive. User device 210 communicates with server 220 over network 230 using transceiver 214. Network 230 could, for example, be the Internet or a cellular telephony network. One or both of memory 212 and server 220 could store a database of merchants registered for particular types of mobile payment.

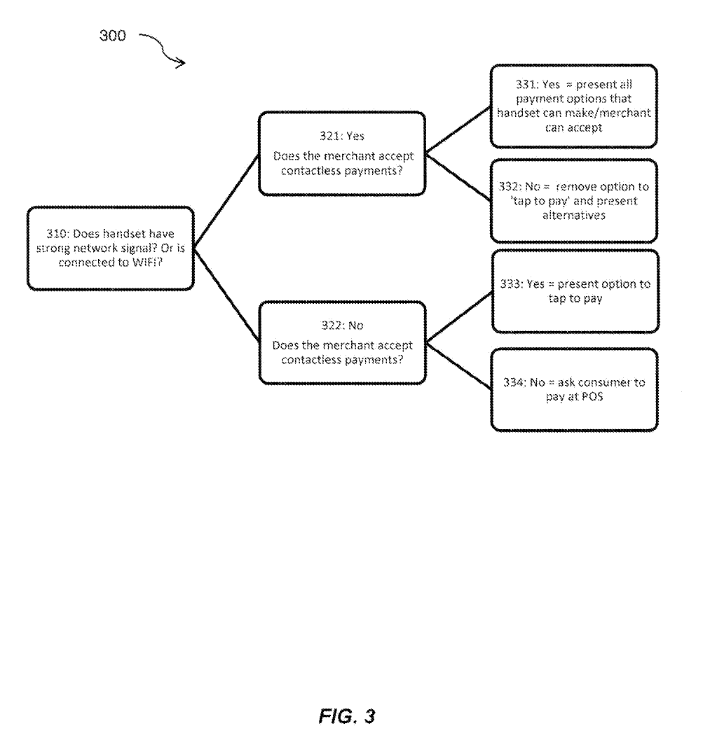

FIG. 3 is a flowchart detailing an example processing flow 300 of presenting payment mode options to a user for a particular transaction, where the user device is equipped with the methods to effect e-commerce payment or contactless payment, constructed and operative in accordance with embodiments of the present disclosure. At 310 it is determined whether the user device (handset) has strong network signal or is connected to WiFi. If the answer to 310 is yes, then at 321 it is determined whether the merchant accepts contactless payments. If the answer to 321 is yes, then at 331 all payment options that the handset can make and the merchant can accept are presented. If the answer to 321 is no, then at 332 the option “tap to pay” is removed and alternatives are presented. If the answer to 310 is no, then at 322 it is determined whether the merchant accepts contactless payments. If the answer to 322 is yes, then at 333 the option “tap to pay” is presented. If the answer to 322 is no, then at 334 the user is presented with a message to pay at a POS.

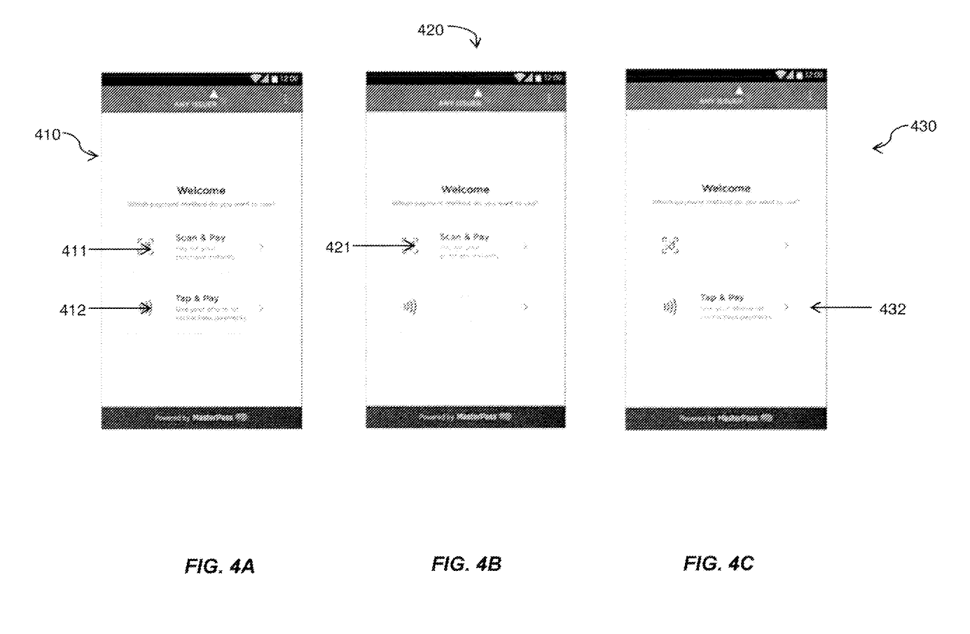

FIGS. 4A to 4C illustrate example Graphical User Interfaces (GUIs) 410, 420, 430 to present the messages of 331, 332 and 333 respectively, constructed and operative in accordance with embodiments of the present disclosure.

In FIG. 4A, both Scan & Pay (e-commerce) and Tap & Pay (contactless) payment modes are available and are shown as such on the screen at 411 and 412. The user can initiate payment by selecting a payment mode. If the screen is a touchscreen this could be by tapping the screen in the location of the appropriate option box.

In FIG. 4B, only Scan & Pay is available, for example because the merchant does not support contactless payment, because there is no contactless POS available nearby or because the mobile device or its subscriber identity module (SIM) is not contactless enabled. Tap & Pay is therefore “greyed out,” shown in watermark to indicate that it is not selectable. Other methods of indicating that Scan & Pay is available but Tap & Pay isn't could be envisaged, for example showing Scan & Pay with a green background and Tap & Pay with a red background, or simply by only presenting Scan & Pay. Scan & Pay can be initiated by selecting Scan & Pay onscreen at 421 as before.

Similarly, in FIG. 4C only Tap & Pay is available, for example because handset signal strength is poor or non-existent and/or there is no WiFi connection available. Again, the other payment mode (Scan & Pay) is greyed out and is not selectable, whereas Tap & Pay is selectable at 432.

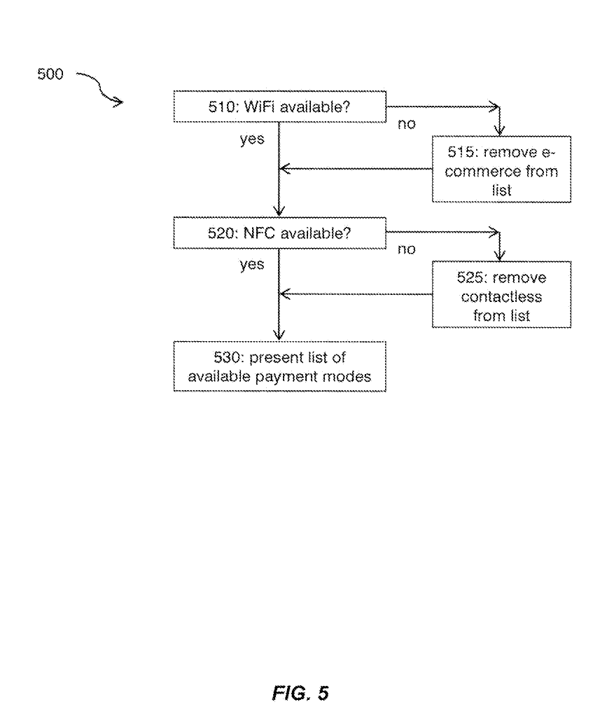

FIG. 5 is a flowchart detailing another example processing flow 500 to present payment mode options to a user for a particular transaction, where the user device is equipped with the methods to effect e-commerce payment or contactless payment, constructed and operative in accordance with embodiments of the present disclosure. At 510 it is determined whether the mobile device (handset) is connected to WiFi or a cellular network. If the answer to 510 is no, then at 515 e-commerce is removed from the list of available payment modes. At 520 it is determined whether NFC payment is available to the user device. If the answer to 520 is no, then at 525 contactless is removed from the list of available payment modes. At 530 the options remaining on the list are presented to the user.

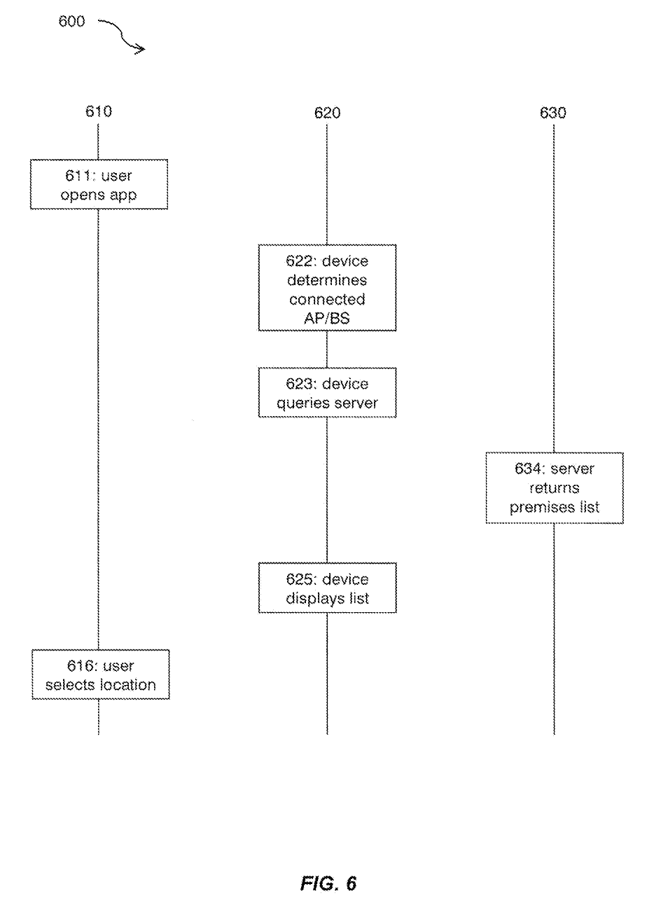

As mentioned above, if the mobile device is connected to a network, for example a wireless personal area network (WPAN) such as a WiFi Bluetooth™ Low Energy (BLE) network, the location of the device could be determined as within range of whatever access point/base station it is connected to. Alternatively, a Global Positioning System (GPS) enabled mobile device could determine its location using GPS satellites. Once the location of the device has been narrowed down in either of these manners, the device could automatically check for registered merchant premises in the vicinity. If there is only one then this is determined to be the user's location. If there are multiple registered merchant premises within the identified region, the user could be presented with a list from which they can choose in order to check-in to the correct location. This procedure could be performed automatically on a user opening a payment app or in response to the user requesting a location and/or available payment modes scan. An example of this type of procedure is set out in FIG. 6.

FIG. 6 is a flowchart illustrating an example method 600 of determining a mobile device's location, constructed and operative in accordance with embodiments of the present disclosure. At 611 a user 610 opens a payment app on their mobile device 620. At 622 the device determines the identity of an access point (AP) or base station (BS) it is connected to a network (such as a WPAN or BILE network) through. This information may be retrievable from the device's memory if the AP/BS identified itself to the mobile device during establishment of the connection between them. Alternatively, the mobile device could transmit a message to the AP/BS requesting that it identify itself, then record the response received. At 623 the device queries a server 630 to request a list of registered premises within range of the identified AP/BS. At 634 the server returns the list to the mobile device. At 625 the device displays the list. Finally, at 616 the user selects the correct current location in order to complete check-in.

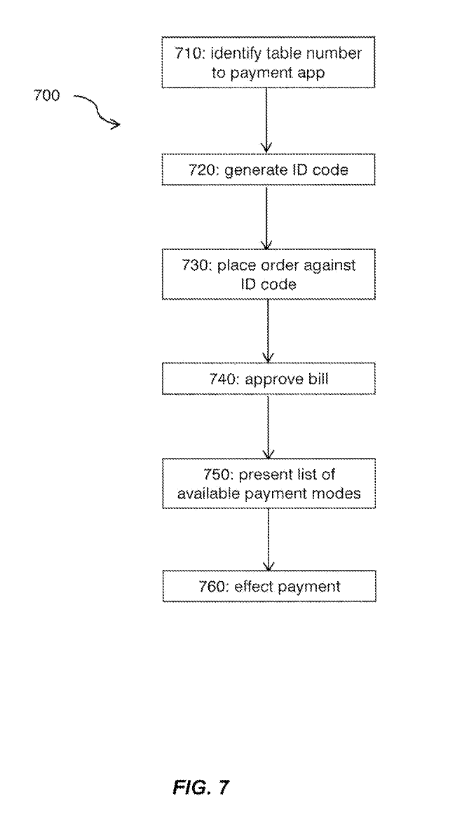

FIG. 7 illustrates an example method 700 of payment mode selection in a restaurant, constructed and operative in accordance with embodiments of the present disclosure. At 710, a customer takes a seat in a restaurant and identifies their table number to a payment app on their mobile device. Method 710 could involve, for instance, scanning a barcode on the table or, having checked-in at the restaurant according to the method of FIG. 6, selecting a table number from a list of available table numbers presented on the mobile device (available table numbers could be retrieved for example from the server, from a restaurant app linked to the payment app or from a restaurant add-on for the payment app). At 720, the mobile device generates an ID code according to the selected table number to identify the user's party. At 730 the customer places an order against the ID code. This could be done by providing a waiter or waitress with the code and ordering in the traditional manner, or by ordering through the payment app or a restaurant app linked to the payment app. At 740 the user views and approves their bill on the mobile device. At 750 the user is provided with a list of available payment modes as described above and at 760 they effect payment. Depending on the modes available, it may be possible to settle the bill and leave the restaurant without having to attract the attention of waiting staff.

Many modifications and variations can be made to the above-described embodiments within the scope of the invention.

Other embodiments will be apparent to those skilled in the art from consideration of the specification and practice of the embodiments disclosed herein. It is intended that the specification and examples be considered as exemplary only, with a true scope and spirit of the invention being indicated by the following claims. In addition, where this application has listed the methods of a method or procedure in a specific order, it could be possible, or even expedient in certain circumstances, to change the order in which some methods are performed, and it is intended that the particular methods of the method or procedure claims set forth herein not be construed as being order-specific unless such order specificity is expressly stated in the claim.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method performed by a mobile device comprising:
electronically polling with a transceiver to determine availability to the mobile device of each of a plurality of communications channels;
determining, with a processor, based on the availability of the each of the plurality of communication channels, that one or more modes of payment are available to a user; and
presenting the user with a list of the one or more modes of payment that is available to the user on a user interface.

2. The method of claim 1, wherein the plurality of communications channels comprise one or more of:
a cellular network communications channel,
a wireless personal area network (WPAN) communications channel and
a Near Field Communication (NFC) channel.

3. The method of claim 2, wherein the determining availability to the mobile device of each of the plurality of communications channels comprises determining a location of the mobile device.

4. The method of claim 3, wherein the location is determined by:
Global Positioning System (GPS) signaling;
identification of the wireless personal area network access point or base station to which the mobile device is connected; or
local check-in by methods of Near Field Communication or bar code scanning.

5. The method of claim 4, wherein the determining that one or more modes of payment are available to the user comprises:
determining a merchant associated with the location; and
determining one or more modes of payment offered by the merchant.

6. The method of claim 5, wherein the one or more modes of payment comprise:
e-commerce,
contactless and
point of sale (POS) transaction.

7. The method of claim 6, wherein determining availability to the mobile device of each of the plurality of communications channels is performed periodically or in response to a device user command.

8. The method of claim 7, further comprising:
when the list comprises one or more mobile modes of payment, effecting mobile payment in response to the user selecting one of the one or more presented mobile modes of payment.

9. The method of claim 8, wherein the user selecting one of the one or more presented mobile modes of payment comprises:
when the selected one of the one or more presented mobile modes of payment is contactless, the user holding the use device proximate to a reader module; and
when the selected one of the one or more presented mobile modes of payment is e-commerce, the user employing a user interface of the user device to:
initiate a bar code scanning function, or
click to pay.

10. A mobile device comprising:
a transceiver configured to electronically poll to determine availability to the mobile device of each of a plurality of communications channels;
a processor configured to determine one or more modes of payment are available to a user based on the availability of the each of the plurality of communication channels; and
a user interface configured to present the user with a list of the one or more modes of payment that are available to the user.

11. The mobile device of claim 10, wherein the transceiver is configured to electronically poll the plurality of communications channels that comprise one or more of:
a cellular network communications channel,
a wireless personal area network (WPAN) communications channel and
a Near Field Communication (NFC) channel.

12. The mobile device of claim 11, wherein the processor determining availability to the mobile device of each of the plurality of communications channels comprises determining a location of the mobile device.

13. The mobile device of claim 12, wherein the location is determined by the processor using:
Global Positioning System (GPS) signaling;
identification of the wireless personal area network access point or base station to which the mobile device is connected; or
local check-in by mobile devices of Near Field Communication or bar code scanning.

14. The mobile device of claim 13, wherein the processor determining that one or more modes of payment are available to the user comprises:
determining a merchant associated with the location; and
determining one or more modes of payment offered by the merchant.

15. The mobile device of claim 14, wherein the one or more modes of payment comprise:
e-commerce,
contactless and
point of sale (POS) transaction.

16. The mobile device of claim 15, wherein the transceiver determining availability to the mobile device of each of the plurality of communications channels is performed periodically or in response to a device user command.

17. The mobile device of claim 16, wherein when the list comprises one or more mobile modes of payment, effecting mobile payment in response to the user selecting one of the one or more presented mobile modes of payment.

18. The mobile device of claim 17, wherein the user selecting one of the one or more presented mobile modes of payment comprises:
when the selected one of the one or more presented mobile modes of payment is contactless, the user holding the user device proximate to a reader module; and
when the selected one of the one or more presented mobile modes of payment is e-commerce, the user employing a user interface of the user device to:
initiate a bar code scanning function, or
click to pay.

19. A non-transitory computer-readable medium encoded with data and instructions, when executed by a computing device the instructions cause the computing device to:
electronically poll with a transceiver to determine availability to the mobile device of each of a plurality of communications channels;
determine, with a processor, based on the availability of the each of the plurality of communication channels, that one or more modes of payment are available to a user; and
present the user with a list of the one or more modes of payment that are available to the user on a user interface.
